(19) United States
(12) Patent Application Publication
(10) Pub. No.: US 2010/0118009 A1
(43) Pub. Date: May 13, 2010

(54) PLASMA DISPLAY PANEL DISPLAY APPARATUS AND METHOD FOR DRIVING THE SAME

(76) Inventors: Masumi Izuchi, Osaka (JP); Toshikazu Wakabayashi, Osaka (JP)

Correspondence Address: MCDERMOTT WILL & EMERY LLP, 600 13TH STREET, NW, WASHINGTON, DC, 20005-3096, US

(21) Appl. No.: 12/524,963

(22) PCT Filed: Nov. 17, 2008
(86) PCT No.: PCT/JP2008/003338

§ 371 Date: Jul. 29, 2009

(30) Foreign Application Priority Data
Dec. 6, 2007 (JP) 2007-315601

(51) Int. Cl. G09G 5/00; G09G 3/28

(52) U.S. Cl. 345/208; 345/60

(57) ABSTRACT

In the case of driving a plasma display panel for one field using a plurality of sub-fields each having a reset period in which reset discharge is generated in a discharge cell, an address period in which address discharge is generated in the discharge cell, and a sustain period in which sustain discharge is generated in the discharge cell, in a former period of the reset period, a rising ramp waveform voltage is applied to the scan electrodes, and a first voltage (Ve1) is applied to the sustain electrodes, and in a latter period of the reset period, a falling ramp waveform voltage is applied to the scan electrodes, and a second voltage (Ve2) higher than the first voltage (Ve1), a rising ramp waveform voltage rising from the second voltage (Ve2) to a third voltage (Ve3) higher than the second voltage (Ve2), and the third voltage (Ve3) are sequentially applied to the sustain electrodes.

### TECHNICAL FIELD

The present invention relates to a plasma display panel display apparatus used as a wall-hung television or a large monitor, and a method for driving the plasma display panel display apparatus.

### BACKGROUND ART

In an alternating current surface discharge PDP display apparatus as a typical plasma display panel display apparatus (hereinafter abbreviated as “PDP display apparatus”), a large number of discharge cells are formed between a front substrate and a back substrate opposed to each other. On the front substrate, plural pairs of display electrodes are formed to be in parallel with each other, and a dielectric layer and a protective layer are formed to cover the pairs of display electrodes. Note that each pair of display electrodes are constituted by a scan electrode and a sustain electrode which forms a pair. On the back substrate, a plurality of data electrodes parallel to one another, a dielectric layer covering the data electrodes, and a parallel-cross dividing wall disposed on the dielectric layer are formed. A phosphor layer is formed on a surface of the dielectric layer and a side surface of the dividing wall. The front substrate and the back substrate are disposed to be opposed to each other such that the display electrodes and the data electrodes are three-dimensionally cross each other. With this, the front substrate and the back substrate are sealed, and discharge spaces inside an assembly of the front substrate and the back substrate are filled with a discharge gas. Discharge cells are formed at portions where the display electrodes and the data electrodes are opposed to each other. In the PDP display apparatus configured as above, ultraviolet is generated by gas discharge in each discharge cell, and causes excitation emission of phosphors of red, green, and blue. Thus, color display is carried out.

A common method for driving the PDP display apparatus is a sub-field method that is a method for dividing one field period into a plurality of sub-fields and carrying out a gray scale display by combinations of the sub-fields in which light is emitted. Each sub-field includes a reset period, an address period, and a sustain period. In the reset period, a predetermined voltage is applied to the scan electrode and the sustain electrode to generate reset discharge (below-described weak discharge), and thus, wall electric charge necessary for an address operation after the reset period is generated on each electrode. In the address period, a scan pulse is sequentially applied to the scan electrodes, and an address pulse is selectively applied to the data electrodes in the discharge cell which should carry out display, thereby generating address discharge. Thus, the wall electric charge is generated. In the sustain period, a sustain pulse is alternately applied to the pairs of display electrodes constituted by the scan electrodes and the sustain electrodes, and sustain discharge is generated in the discharge cell in which the address discharge has been generated. With this, the phosphor layer of the corresponding discharge cell is caused to emit light, thereby carrying out image display.

Among such methods for driving the PDP display apparatus, disclosed is a method for reducing the cost and the power consumption of a data electrode drive circuit by lowering a withstand voltage of the data electrode drive circuit in such a manner that the voltage of the scan pulse applied to the scan electrode is set to be lower than the voltage of the scan electrode at the time of termination of application of a reset waveform, and the voltage of the sustain electrode in the address period is set to be lower than the voltage of the sustain electrode at the time of termination of application of the reset waveform (see Patent Document 1 for example).

Moreover, disclosed is a driving method for reducing light emission unrelated to the gray scale display as much as possible and improving a contrast ratio by limiting the number of generations of the reset discharge in all the discharge cells in the reset period (see Patent Document 2 for example).

Patent Document 1: Japanese Laid-Open Patent Application Publication 2000-305510

Patent Document 2: Japanese Laid-Open Patent Application Publication 2000-242224

### DISCLOSURE OF THE INVENTION

### Problems to be Solved by the Invention

However, by limiting the number of generations of the reset discharge in all the discharge cell, the address discharge becomes unstable, and this may cause malfunctions, i.e., the sustain discharge may not be generated in the discharge cell in which the sustain discharge should be generated, or the sustain discharge may be generated in the discharge cell in which the sustain discharge should not be generated. Especially, the improvement of high definition of the PDP display apparatus is significant in recent years, and the above malfunctions tend to be caused as the discharge cells become minute. Moreover, the increase in speed of the driving is required in accordance with the increase in number of the scan electrodes by the improvement of high definition of the PDP display apparatus. To increase the speed of the driving, the drive voltage needs to be set to be high, and this causes a tendency to cause the above-described malfunctions.

The present invention was made in view of the above problems, and an object of the present invention is to provide a PDP display apparatus capable of generating stable address discharge and carrying out stable image display at high speed even if the PDP display apparatus is a high-definition PDP display apparatus, and a method for driving the PDP display apparatus.

### Means for Solving the Problems

In order to solve the above problems, the present invention provides a method for driving a PDP display apparatus in which in a case of driving a plasma display panel for one field using a plurality of sub-fields each having a reset period in which reset discharge is generated in the discharge cell, an address period which is a period after the reset period and in which address discharge is generated in the discharge cell, and a sustain period which is a period after the address period and in which sustain discharge is generated in the discharge cell, in the reset period, after a rising ramp waveform voltage is applied to the scan electrodes, and a first voltage is applied to the sustain electrodes, a falling ramp waveform voltage is applied to the scan electrodes, and a second voltage higher than the first voltage, a rising ramp waveform voltage rising from the second voltage to a third voltage higher than the second voltage, and the third voltage are sequentially applied to the sustain electrodes. The present invention also provides the PDP display apparatus configured to be able to drive as above.

Moreover, in the PDP display apparatus and the driving method thereof according to the present invention, it is desirable that in the address period, a fourth voltage which is higher than the first voltage and is different from the third voltage be applied to the sustain electrodes, and a scan pulse of a voltage set to be lower than a lowest voltage of the falling ramp waveform voltage be sequentially applied to each of the scan electrodes.

Further, in the PDP display apparatus and the driving method thereof according to the present invention, it is preferable that the second voltage be set to a voltage which does not generate strong discharge between the sustain electrode and the data electrode or strong discharge between the sustain electrode and the scan electrode.

In the driving of the PDP display apparatus, two types of discharge modes, i.e., a weak discharge mode and a strong discharge mode are used in the discharge cell. In the weak discharge mode, discharge (above-described reset discharge for example) capable of generating a wall voltage not more than a change voltage with respect to the discharge start voltage is generated. In contrast, in the strong discharge mode, discharge (above-described address discharge for example) capable of generating a voltage exceeding the change voltage with respect to the discharge start voltage is generated.

As described above, the present invention has a feature that the second voltage is appropriately set to prevent the strong discharge from being generated in the discharge cell in the reset period. Therefore, to clarify the feature in the detailed explanation of the following embodiment, a term “weak discharge” or “weak” discharge may be used as the former discharge, and a term “strong discharge” may be used as the latter discharge in the explanation of the operations of the PDP display apparatus.

The above object, other objects, features and advantages of the present invention will be made clear by the following detailed explanation of a preferred embodiment with reference to the attached drawings.

### EFFECTS OF THE INVENTION

The present invention can provide a PDP display apparatus capable of generating stable address discharge and carrying out stable image display at high speed even if the PDP display apparatus is a high-definition PDP display apparatus, and a method for driving the PDP display apparatus.

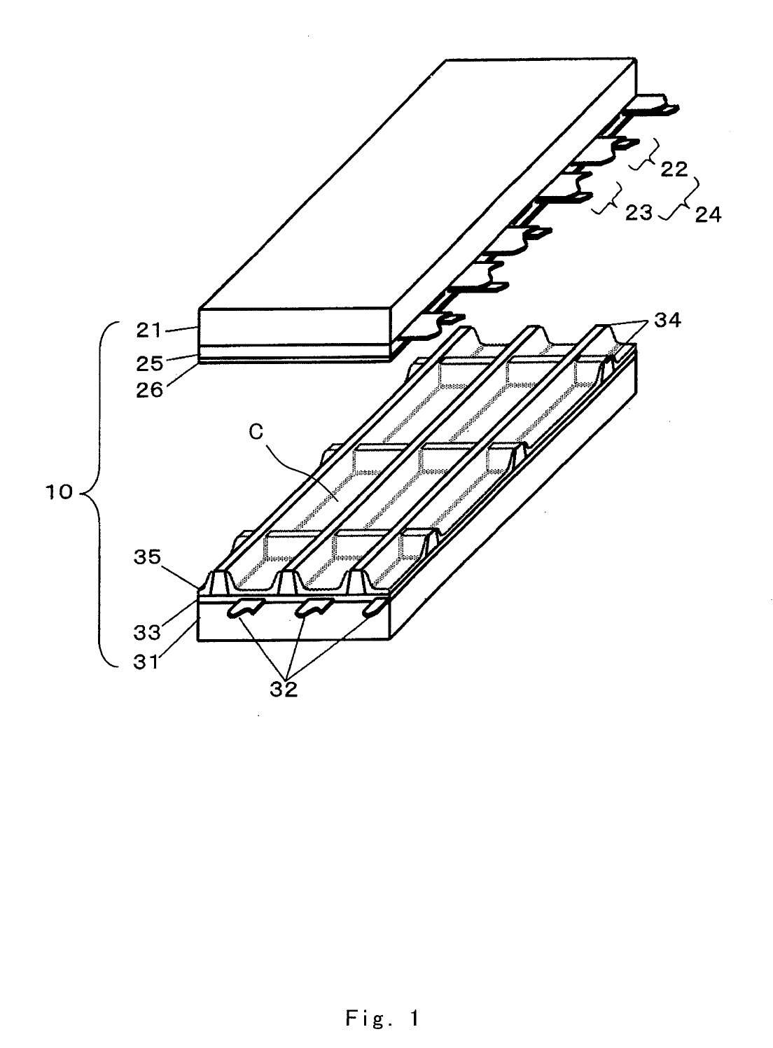

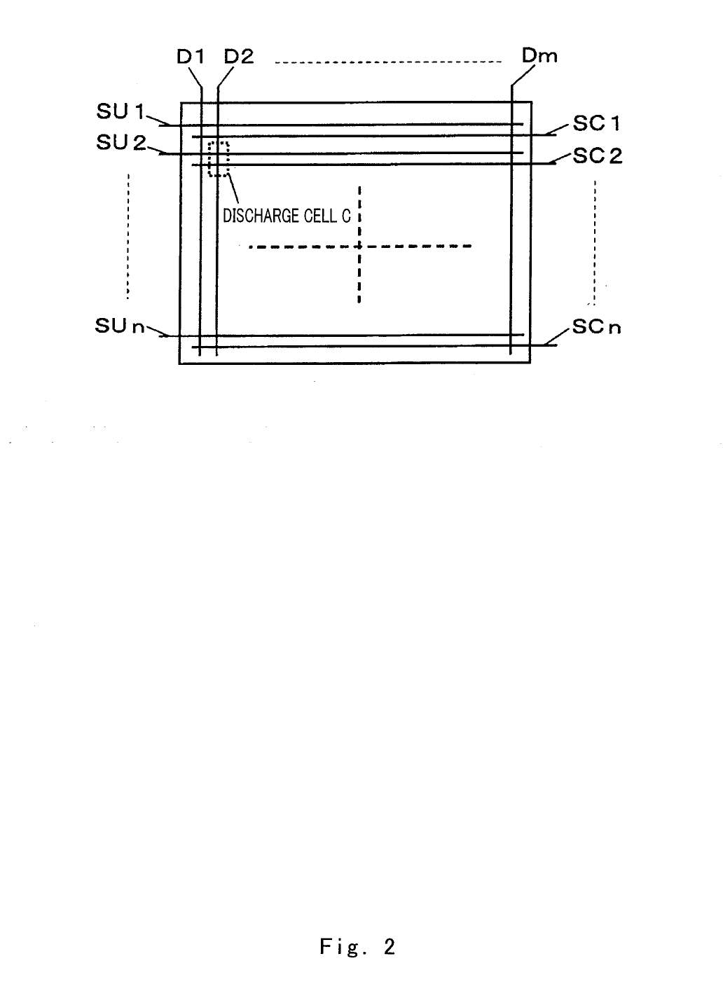

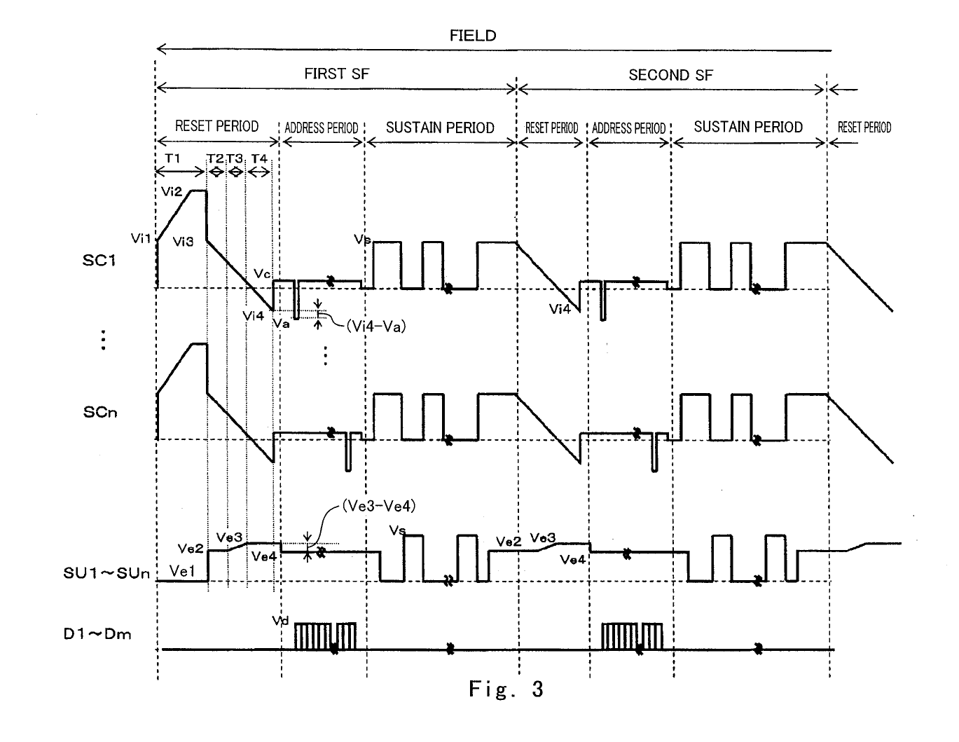

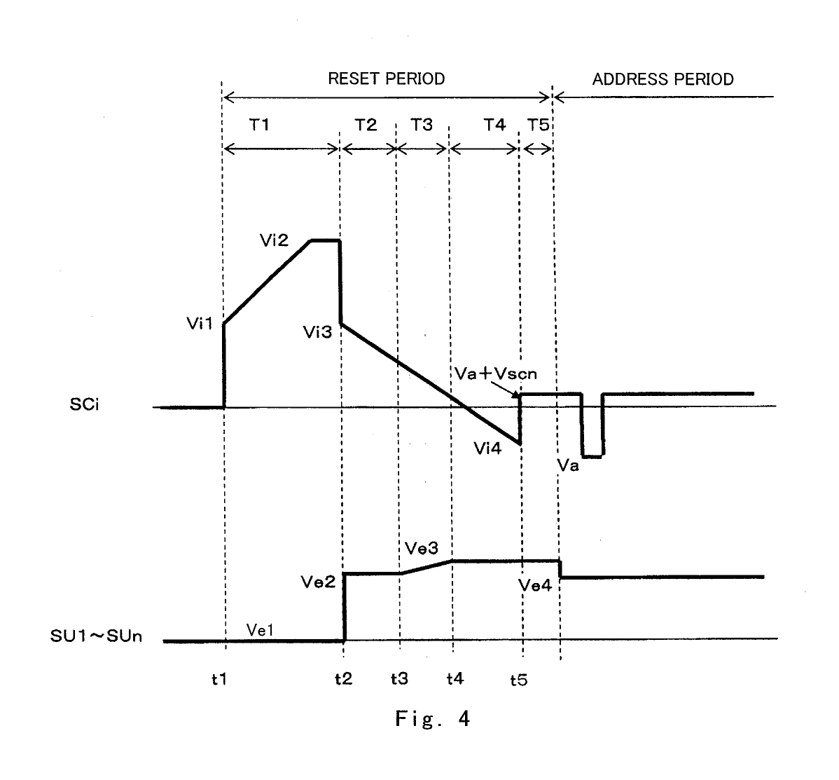

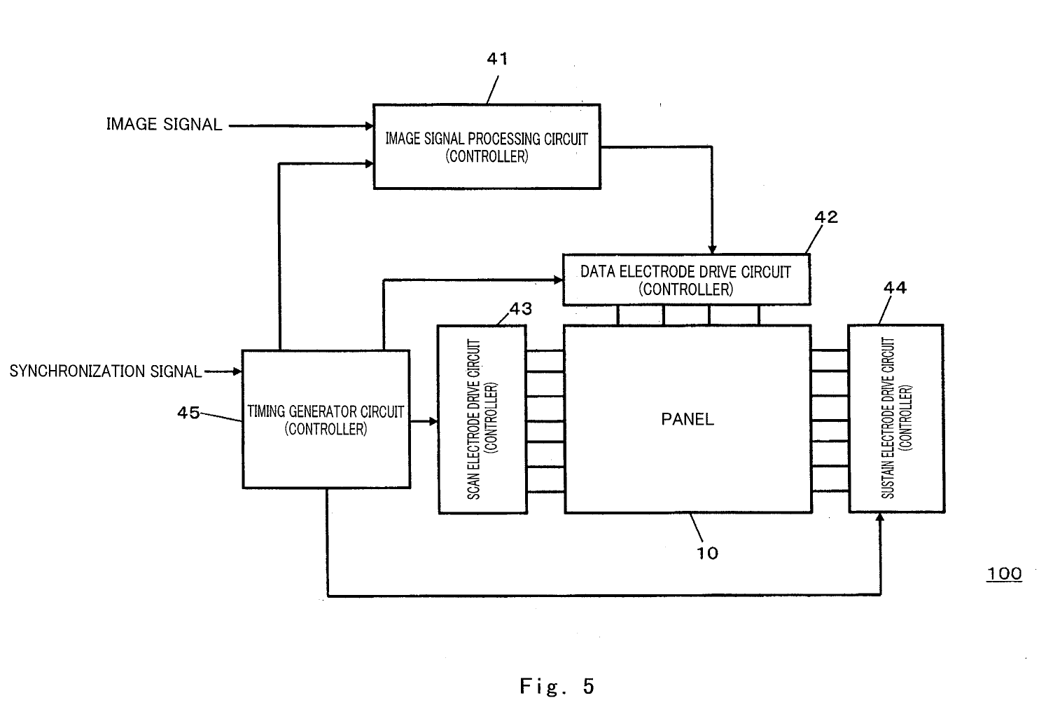

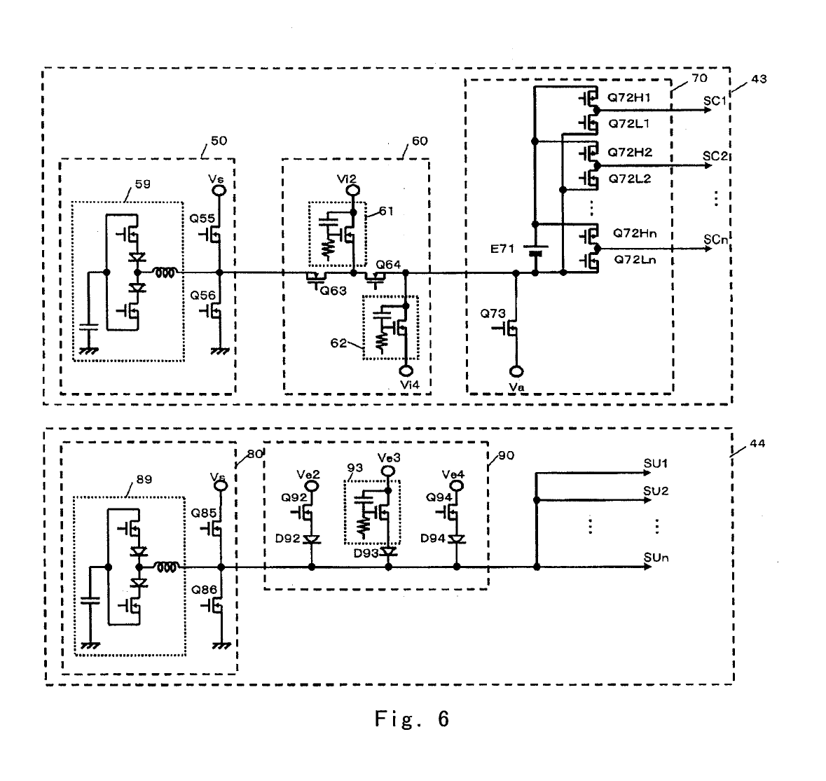

### BRIEF DESCRIPTION OF THE DRAWINGS

[FIG. 1] FIG. 1 is an exploded perspective view showing the configuration of a plasma display panel of a PDP display apparatus in an embodiment of the present invention.

[FIG. 2] FIG. 2 is a diagram showing the arrangement of electrodes of the plasma display panel of FIG. 1.

[FIG. 3] FIG. 3 is a diagram showing drive voltage waveforms applied to respective electrodes of the plasma display panel of FIG. 1.

[FIG. 4] FIG. 4 is a detail view of the drive voltage waveform diagram of FIG. 3.

[FIG. 5] FIG. 5 is a circuit block diagram of the PDP display apparatus in the embodiment of the present invention.

[FIG. 6] FIG. 6 is a circuit diagram showing details of a scan electrode drive circuit and a sustain electrode drive circuit in the PDP display apparatus of FIG. 5.

### EXPLANATION OF REFERENCE NUMBERS

10 plasma display panel

22 scan electrode

23 sustain electrode

32 data electrode

41 image signal processing circuit (controller)

42 data electrode drive circuit (controller)

43 scan electrode drive circuit (controller)

44 sustain electrode drive circuit (controller)

45 timing generator circuit (controller)

50, 80 sustain pulse generating circuit

60 reset waveform generating circuit

70 scan pulse generating circuit

90 reset-address voltage generating circuit

100 PDP display apparatus

C discharge cell

### BEST MODE FOR CARRYING OUT THE INVENTION

Hereinafter, a method for driving a PDP display apparatus in an embodiment of the present invention and the configuration of the PDP display apparatus will be explained in reference to the drawings.

### Embodiment

FIG. 1 is an exploded perspective view showing the configuration of a plasma display panel 10 of the PDP display apparatus in the embodiment of the present invention. Plural pairs of display electrodes 24 are formed on a front substrate 21 made of glass, and each pair of display electrodes 24 are constituted by a scan electrode 22 and a sustain electrode 23. A dielectric layer 25 is formed to cover the scan electrodes 22 and the sustain electrodes 23, and a protective layer 26 is formed on the dielectric layer 25. A plurality of data electrodes 32 are formed on a back substrate 31. A dielectric layer 33 is formed to cover the data electrodes 32, and a parallel-cross dividing wall 34 is formed on the dielectric layer 33. Phosphor layers 35 which emit red, green, or blue light are provided on side surfaces of the dividing wall 34 and on the dielectric layer 33.

The front substrate 21 and the back substrate 31 are disposed to be opposed to each other such that a weak discharge space is sandwiched therebetween, and the display electrodes 24 and the data electrodes 32 intersect with each other. An outer peripheral portion of an assembly of the front substrate 21 and the back substrate 31 is sealed by a sealing material, such as glass flit. For example, a mixture gas of neon and xenon is filled in the discharge space as a discharge gas. The discharge space is divided into a plurality of sections by the dividing wall 34, and discharge cells C are formed at portions where the display electrodes 24 and the data electrodes 32 intersect with each other. Images are displayed by the discharge and light emission of the discharge cells C.

The configuration of the plasma display panel is not limited to this, and the plasma display panel may include, for example, a stripe dividing wall.

FIG. 2 is a diagram showing the arrangement of electrodes of the plasma display panel 10 of the PDP display apparatus in the embodiment of the present invention. In the plasma display panel 10, n scan electrodes SC1 to SCn (scan electrodes 22 of FIG. 1) extending in a row direction and n sustain electrodes SU1 to SUn (sustain electrodes 23 of FIG. 1) extending in the row direction are arranged, and m data electrodes D1 to Dm (data electrodes 32 of FIG. 1) extending in a column direction are arranged. The discharge cell C is formed at a portion where a pair of the scan electrode SCi (i=1 to n) and the sustain electrode SUi (i=1 to n) and one data electrode Dj (j=1 to m) intersect with one another, and the number of discharge cells C in the discharge space is m×n.

Next, drive voltage waveforms for driving the plasma display panel 10 and operations of the plasma display panel 10 will be explained. The PDP display apparatus using the plasma display panel 10 carries out gray scale display by a sub-field method that is a method for dividing one field period into a plurality of sub-fields and controlling light emission and non-emission of respective discharge cells C in each sub-field. Each sub-field includes a reset period, an address period, and a sustain period. In the reset period, weak reset discharge is caused to generate, on each electrode, wall electric charge necessary for an address discharge generated after the reset period. As this reset operation, there are two types that are a reset operation (hereinafter abbreviated as “all-cell reset operation”) of causing the weak reset discharge in all the discharge cells C and a reset operation (hereinafter abbreviated as “selective reset operation”) of causing the weak reset discharge in the discharge cells C in which the sustain discharge has been generated in the immediately preceding sub-field. In the address period, the address discharge is selectively generated in the discharge cells C which should emit light, thereby generating the wall electric charge. In the sustain period, the sustain pulses, the number of which is proportional to a brightness degree, are alternately applied to the pairs of display electrodes to generate the sustain discharge proportional to the brightness degree in the discharge cell C in which the address discharge has been generated. Thus, the light is emitted.

In the present embodiment, one field is divided into ten sub-fields (a first SF, a second SF, . . . , and a tenth SF), and these sub-fields respectively have the brightness degrees that are, for example, 1, 2, 3, 6, 11, 18, 30, 44, 60, and 80. In addition, the all-cell reset operation is carried out in the reset period of the first SF, and the selective reset operation is carried out in the reset period of each of the second SF to the tenth SF.

Moreover, in the sustain period of each sub-field, the sustain pulses, the number of which is a number obtained by multiplying the brightness degree of the sub-field by a predetermined brightness magnification, are applied to each of the pairs of display electrodes.

However, the number of sub-fields and the brightness degrees of the sub-fields in the present invention are not limited to the above values. Moreover, the configuration of the sub-fields may be switched based on the image signal and/or the like.

FIG. 3 is a diagram showing drive voltage waveforms applied to respective electrodes of the plasma display panel 10 of the PDP display apparatus in the embodiment of the present invention. FIG. 3 shows the sub-field in which the all-cell reset operation is carried out and the sub-field in which the selective reset operation is carried out. FIG. 4 is a detail view of the drive voltage waveform diagram of FIG. 3, and shows the reset period in which the all-cell reset operation is carried out, and a part of the address period.

First, the sub-field in which the all-cell reset operation is carried out will be explained.

In a period T1 that is a former period of the reset period, the voltage of 0 volt is applied to the data electrodes D1 to Dm, and the voltage of 0 volts as a first voltage Ve1 is applied to the sustain electrodes SU1 to SUn. A ramp waveform voltage moderately rising from a voltage Vi1 to a voltage Vi2 based on the voltage of the sustain electrodes SU1 to SUn is applied to the scan electrodes SC1 to SCn. The voltage Vi1 is a discharge start voltage or lower, and the voltage Vi2 is higher than the discharge start voltage. While the ramp waveform voltage is rising, the weak reset discharge is generated between the scan electrodes SC1 to SCn and the sustain electrodes SU1 to SUn, and between the scan electrodes SC1 to SCn and the data electrodes D1 to Dm. With this, negative wall voltages are accumulated on portions above the scan electrodes SC1 to SCn, and positive wall voltages are accumulated on portions above the data electrodes D1 to Dm and portions above the sustain electrodes SU1 to SUn. Here, the wall voltage on the portion above the electrode denotes a voltage generated by the wall electric charge accumulated on the dielectric layer, the protective layer, the phosphor layer, and the like which cover the electrode.

In periods T2 to T4 that are a latter period of the reset period after the former period of the reset period, the ramp waveform voltage moderately falling from a voltage Vi3 to a lowest voltage Vi4 based on the voltage of the sustain electrodes SU1 to SUn is applied to the scan electrodes SC1 to SCn. The voltage Vi3 is the discharge start voltage or lower, and the lowest voltage Vi4 is higher than the discharge start voltage. During this, a second voltage Ve2 higher than the first voltage Ve1 (herein, 0 volt), a rising ramp waveform voltage rising from the second voltage Ve2 to the third voltage Ve3 higher than the second voltage, and the third voltage Ve3 are sequentially applied to the sustain electrodes SU1 to SUn. Hereinafter, details will be explained in order.

First, in the period T2 of the reset period, the positive second voltage Ve2 is applied to the sustain electrodes SU1 to SUn. During this, the weak reset discharge starts between the scan electrodes SC1 to SCn and the sustain electrodes SU1 to SUn.

In the period T3 of the reset period, the rising ramp waveform voltage moderately rising from the second voltage Ve2 to the third voltage Ve3 is applied to the sustain electrodes SU1 to SUn. During this, the weak reset discharge between the scan electrodes SC1 to SCn and the sustain electrodes SU1 to SUn weakens the negative wall voltage on the portions above the scan electrodes SC1 to SCn and the positive wall voltage on the portions above the sustain electrodes SU1 to SUn.

In the period T4 of the reset period, the positive third voltage Ve3 is applied to the sustain electrodes SU1 to SUn. During this, in addition to the weak reset discharge between the scan electrodes SC1 to SCn and the sustain electrodes SU1 to SUn, the weak reset discharge is generated between the scan electrodes SC1 to SCn and the data electrodes D1 to Dm. With this, the negative wall voltage on the portions above the scan electrodes SC1 to SCn and the positive wall voltage on the portions above the sustain electrodes SU1 to SUn are weakened, and the positive wall voltage on the portions above the data electrodes D1 to Dm is adjusted to a value suitable for an address operation. Thus, even in the case of the discharge cells C having different discharge start voltages, conditions for causing the address discharge can be set to be the same among the discharge cells C.

Thus, the all-cell reset operation of causing the weak reset discharge in all the discharge cells C terminates.

In the address period after the reset period, a voltage Vc is applied to the scan electrodes SC1 to SCn, and the voltage of 0 volt is applied to the data electrodes D1 to Dm. In addition, a fourth voltage Ve4 higher than the first voltage Ve1 (herein, 0 volt) and lower than the third voltage Ve3 is applied to the sustain electrodes SU1 to SUn.

Next, a scan pulse of a voltage Va set to be lower than the lowest voltage Vi4 of the falling ramp waveform voltage is applied to the scan electrode SC1 on the first line, and an address pulse voltage Vd is applied to a data electrode Dk (k=1 to m) corresponding to the discharge cell C which should emit light. In this case, a voltage difference at an intersecting portion of the data electrode Dk and the scan electrode SC1 becomes a value obtained by adding the difference (Vd−Va) between externally applied voltages to the difference between the wall voltage on the data electrode Dk and the wall voltage on the scan electrode SC1, and exceeds the discharge start voltage. Then, the discharge between the data electrode Dk and the scan electrode SC1 starts, and develops into the discharge between the sustain electrode SU1 and the scan electrode SC1. Thus, the address discharge is generated. As a result, the positive wall voltage is accumulated on the scan electrode SC1, the negative wall voltage is accumulated on the sustain electrode SU1, and the negative wall voltage is also accumulated on the data electrode Dk. Thus, the address operation of causing the address discharge in the discharge cell C which should emit light on the first line and accumulating the wall voltage on the electrode is carried out. Meanwhile, since the voltage at the intersecting portion of the data electrodes D1 to Dm to which the address pulse voltage Vd is not applied and the scan electrode SC1 does not exceed the discharge start voltage, the address discharge is not generated.

Here, by applying to the scan electrode SC1 the scan pulse of the voltage Va set to be lower than the lowest voltage Vi4 of the falling ramp waveform voltage, the voltage difference at the intersecting portion of the data electrode Dk and the scan electrode SC1 increases by the difference (Vi4−Va) between the lowest voltage Vi4 and the voltage Va of the scan pulse. Thus, the address discharge can be easily generated. However, by applying to the scan electrode SC1 the scan pulse of the voltage Va set to be lower than the lowest voltage Vi4 of the falling ramp waveform voltage, the voltage difference between the sustain electrode SU1 and the scan electrode SC1 also increases by the difference (Vi4−Va) between the lowest voltage Vi4 and the voltage Va of the scan pulse. Therefore, when the voltage Va of the scan pulse is applied, false discharge tends to be generated between the sustain electrode SU1 and the scan electrode SC1 in the discharge cell C which does not carry out display. On this account, by applying the fourth voltage Ve4 to the sustain electrodes SU1 to SUn before the application of the voltage Va of the scan pulse, the voltage difference between the sustain electrode SU1 and the scan electrode SC1 can be reduced by the difference (Ve3−Ve4) between the third voltage Ve3 and the fourth voltage Ve4. With this, when the voltage Va of the scan pulse is applied, the false discharge can be suppressed between the sustain electrode SU1 and the scan electrode SC1 in the discharge cell C which does not carry out display.

In the present embodiment, to generate stable address discharge, the voltage of the difference (Ve3−Ve4) between the third voltage Ve3 and the fourth voltage Ve4 is set to be substantially the same as the voltage of the difference (Vi4−Va) between the lowest voltage Vi4 and the voltage Va of the scan pulse. However, it is desirable that these voltages of the differences be appropriately set depending on, for example, a discharge characteristic of the plasma display panel.

Next, the scan pulse of the voltage Va set to be lower than the lowest voltage Vi4 of the falling ramp waveform voltage is applied to the scan electrode SC2 on the second line, and the address pulse voltage Vd is applied to the data electrode Dk corresponding to the discharge cell C which should emit light. Thus, the address discharge is generated in the discharge cell C on the second line to which cell the voltage Va of the scan pulse and the address pulse voltage Vd are applied at the same time. With this, the address operation is carried out.

The above-described address operation is repeated until the discharge cells C on the n-th line, and the address discharge is selectively generated in the discharge cell C which should emit light, thereby generating the wall electric charge.

In the sustain period after the address period, first, a positive sustain pulse voltage Vs is applied to the scan electrodes SC1 to SCn, and the voltage of 0 volt is applied to the sustain electrodes SU1 to SUn. In this case, in the discharge cell C in which the address discharge has been generated, the voltage difference between the scan electrode SCi and the sustain electrode SUi becomes a value obtained by adding to the sustain pulse voltage Vs a difference between the wall voltage on the scan electrode SCi and the wall voltage on the sustain electrode SUi, and exceeds the discharge start voltage. Then, the sustain discharge is generated between the scan electrode SCi and the sustain electrode SUi, and the ultraviolet generated at this time causes the phosphor layer 35 to emit light. Then, the negative wall voltage is accumulated on the scan electrode SCi, and the positive wall voltage is accumulated on the sustain electrode SUi. Further, the positive wall voltage is accumulated on the data electrode Dk. The sustain discharge is not generated in the discharge cell C in which the address discharge has not been generated in the address period, and the wall voltage at the time of termination of the reset period is maintained.

Next, the voltage of 0 volt is applied to the scan electrodes SC1 to SCn, and the sustain pulse voltage Vs is applied to the sustain electrodes SU1 to SUn. In this case, in the discharge cell C in which the sustain discharge has been generated, the voltage difference between the sustain electrode SUi and the scan electrode SCi exceeds the discharge start voltage. Therefore, the sustain discharge is generated again between the sustain electrode SUi and the scan electrode SCi, so that the negative wall voltage is accumulated on the sustain electrode SUi, and the positive wall voltage is accumulated on the scan electrode SCi. Similarly, the sustain pulses, the number of which is a number obtained by multiplying the brightness degree by the brightness magnification, are alternately applied to the scan electrodes SC1 to SCn and the sustain electrodes SU1 to SUn, thereby generating the potential difference between the pair of display electrodes. With this, the sustain discharge is continuously carried out in the discharge cell C in which the address discharge has been generated in the address period.

Then, at the end of the sustain period, a so-called narrow pulse voltage difference or inclined voltage difference is applied between the scan electrodes SC1 to SCn and the sustain electrodes SU1 to SUn. With this, the positive wall voltage on the data electrode Dk remains, and the wall voltage on the scan electrode SCi and the wall voltage on the sustain electrode SUi are deleted. Thus, a sustain operation in the sustain period terminates.

Next, operations in the sub-field in which the selective reset operation is carried out will be explained.

In the reset period in which the selective reset operation is carried out, the same driving as in the periods T2 to T4 that are the latter period of the reset period in which the all-cell reset operation is carried out is carried out. To be specific, the ramp waveform voltage moderately falling from the voltage Vi3 to the lowest voltage Vi4 is applied to the scan electrodes SC1 to SCn. During this, the voltage of 0 volt is applied to the data electrodes D1 to Dm, and the second voltage Ve2, the rising ramp waveform voltage rising from the second voltage Ve2 to the third voltage Ve3 higher than the second voltage Ve2, and the third voltage Ve3 are sequentially applied to the sustain electrodes SU1 to SUn. In this case, the weak reset discharge is generated in the discharge cell C in which the sustain discharge has been generated in the sustain period of the preceding sub-field. With this, the wall voltage on the scan electrode SCi and the wall voltage on the sustain electrode SUi are weakened. Moreover, since the positive wall voltage is adequately accumulated on the data electrode Dk by the immediately preceding sustain discharge, an excess part of the wall voltage is discharged, and thus the wall voltage is adjusted to be suitable for the address operation. Meanwhile, the weak discharge is not generated in the discharge cell C in which the sustain discharge has not been generated in the preceding sub-field, and the wall electric charge at the time of termination of the reset period in the preceding sub-field is maintained. As above, the selective reset operation is an operation of selectively causing the weak reset discharge in the discharge cell C in which the sustain operation has been carried out in the sustain period of the immediately preceding sub-field.

The operation in the address period after the reset period is the same as the operation in the address period of the sub-field in which the all-cell reset operation is carried out, and the operation in the sustain period is the same as the operation in the sustain period of the sub-field in which the all-cell reset operation is carried out except for the number of sustain pulses, so that explanations thereof are omitted.

The operation in the sub-field after the sub-field shown in FIG. 3 is the same as the operation in the sub-field in which the above-described selective reset operation is carried out.

In the present embodiment, the voltages applied to the scan electrodes SC1 to SCn are as below. The voltage Vi1 is 180 volts, the voltage Vi2 is 420 volts, the voltage Vi3 is 180 volts, the lowest voltage Vi4 is −95 volts, the voltage Va of the scan pulse is −100 volts, and the voltage Vs is 180 volts. The voltages applied to the sustain electrodes SU1 to SUn are as below. The second voltage Ve2 is 150 volts, the third voltage Ve3 is 155 volts, and the fourth voltage Ve4 is 150 volts. The temporal gradient of each of the rising ramp waveform voltage and the falling ramp waveform voltage applied to the scan electrodes SC1 to SCn is not more than 10 V/μ, and the temporal gradient of the rising ramp waveform voltage applied to the sustain electrodes SU1 to SUn in the period T2 is also not more than 10 V/μ. However, these voltage values are not limited to the above-described values, and it is desirable that the voltage values be appropriately set based on the discharge characteristic of the plasma display panel and the specs of the PDP display apparatus. It should be noted that it is desirable that the voltage Va of the scan pulse be set to be lower than the lowest voltage Vi4 of the falling ramp waveform voltage. In addition, it is desirable that the third voltage Ve3 be higher than the second voltage Ve2. It is important that the fourth voltage Ve4 be set to a voltage different from the third voltage Ve3.

As above, in the present embodiment, in the former period of the reset period of the sub-field in which the all-cell reset operation is carried out, the rising ramp waveform voltage rising from the voltage Vi1 to the voltage Vi2 is applied to the scan electrodes SC1 to SCn, and the first voltage Ve1 (herein, 0 volt) is applied to the sustain electrodes SU1 to SUn. In the latter period of the reset period, the falling ramp waveform voltage falling from the voltage Vi3 to the lowest voltage Vi4 is applied to the scan electrodes SC1 to SCn, and the second voltage Ve2 higher than the first voltage Ve1 (herein, 0 volt), the rising ramp waveform voltage rising from the second voltage Ve2 to the third voltage Ve3 higher than the second voltage Ve2, and the third voltage Ve3 are sequentially applied to the sustain electrodes SU1 to SUn. Then, in the address period after the reset period, the fourth voltage Ve4 higher than the first voltage Ve1 (herein, 0 volt) and lower than the third voltage Ve3 is applied to the sustain electrodes SU1 to SUn, and the scan pulse of the voltage Va set to be lower than the lowest voltage Vi4 of the falling ramp waveform voltage is sequentially applied to the scan electrodes SC1 to SCn.

Then, a PDP display apparatus 100 of the present embodiment using the above driving method can achieve the following advantageous effects as compared to a conventional PDP display apparatus.

In the conventional PDP display apparatus, generally, when the third voltage Ve3 is steeply applied to the sustain electrodes SU1 to SUn in the case of applying the falling ramp waveform voltage to the scan electrodes SC1 to SCn in the latter period of the reset period, the false discharge due to the strong discharge between the sustain electrodes SU1 to SUn and the data electrodes D1 to Dm or between the sustain electrodes SU1 to SUn and the scan electrodes SC1 to SCn tends to be generated in the discharge cell C.

In contrast, in the PDP display apparatus 100 of the present embodiment, the second voltage Ve2 set so as not to generate the strong discharge between the above-described electrodes is steeply applied to the sustain electrodes SU1 to SUn in the latter period of the reset period, and then, the rising ramp waveform voltage rising from the second voltage Ve2 to the third voltage Ve3, and the third voltage Ve3 are sequentially applied to the sustain electrodes SU1 to SUn. Thus, the false discharge due to the strong discharge in the discharge cell C can be suppressed, and stable weak reset discharge is realized.

Next, examples of drive circuits configured to generate the above-described drive voltages will be explained.

FIG. 5 is a circuit block diagram of the PDP display apparatus 100 in the embodiment of the present invention.

The PDP display apparatus 100 includes the plasma display panel 10, an image signal processing circuit 41, a data electrode drive circuit 42, a scan electrode drive circuit 43, a sustain electrode drive circuit 44, a timing generator circuit 45, and a power supply circuit (not shown) configured to supply power supply necessary for respective circuit blocks. The above-described circuits (the image signal processing circuit 41, the data electrode drive circuit 42, the scan electrode drive circuit 43, the sustain electrode drive circuit 44, and the timing generator circuit 45) constitute a controller configured to control the plasma display panel 10.

The image signal processing circuit 41 converts an input image signal into image data indicating light emission or light non-emission of each sub-field. The data electrode drive circuit 42 converts the image data of each sub-field into a signal corresponding to each of the data electrodes D1 to Dm and drives each of the data electrodes D1 to Dm. The timing generator circuit 45 generates based on a horizontal synchronization signal and a vertical synchronization signal, various timing signals for controlling the operations of the circuit blocks, and supplies the timing signals to the circuit blocks. The scan electrode drive circuit 43 drives the scan electrodes SC1 to SCn based on the timing signals. The sustain electrode drive circuit 44 drives the sustain electrodes SU1 to SUn based on the timing signals.

FIG. 6 is a circuit diagram showing the scan electrode drive circuit 43 and the sustain electrode drive circuit 44 in the embodiment of the present invention.

The scan electrode drive circuit 43 includes a sustain pulse generating circuit 50, a reset waveform generating circuit 60, and a scan pulse generating circuit 70. The sustain pulse generating circuit 50 includes a switching element Q55 for applying the voltage Vs to the scan electrodes SC1 to SCn, a switching element Q56 for applying the voltage of 0 volt to the scan electrodes SC1 to SCn, and an electric power recovering circuit 59 for recovering the electric power used when the sustain pulse is applied to the scan electrodes SC1 to SCn. The reset waveform generating circuit 60 includes a Miller integrator 61 for applying the rising ramp waveform voltage to the scan electrodes SC1 to SCn and a Miller integrator 62 for applying the falling ramp waveform voltage to the scan electrodes SC1 to SCn. A switching element Q63 and a switching element Q64 are provided in the reset waveform generating circuit 60 to prevent the current from flowing backward through, for example, a parasitic diode of the other switching element. The scan pulse generating circuit 70 includes a floating power supply E71 of the voltage Vscn, switching elements Q72H1 to Q72Hn and Q72L1 to Q72Ln for applying a high voltage or a low voltage of the floating power supply E71 to each of the scan electrodes SC1 to SCn, and a switching element Q73 for fixing the low voltage of the floating power supply E71 to the voltage Va of the scan pulse.

The sustain electrode drive circuit 44 includes a sustain pulse generating circuit 80 and a reset-address voltage generating circuit 90. The sustain pulse generating circuit 80 includes a switching element Q85 for applying the voltage Vs to the sustain electrodes SU1 to SUn, a switching element Q86 for applying the voltage of 0 volt to the sustain electrodes SU1 to SUn, and an electric power recovering portion 89 for recovering the electric power used when the sustain pulse is applied to the sustain electrodes SU1 to SUn. The reset-address voltage generating circuit 90 includes a switching element Q92 and diode D92 for applying the second voltage Ve2 to the sustain electrodes SU1 to SUn, a Miller integrator 93 and diode D93 for applying to the sustain electrodes SU1 to SUn the rising ramp waveform voltage moderately rising to the third voltage Ve3, and a switching element Q94 and diode D94 for applying the fourth voltage Ve4 to the sustain electrodes SU1 to SUn.

These switching elements can be configured using generally known elements, such as MOSFET and IGBT.

Next, operations of the scan electrode drive circuit 43 and the sustain electrode drive circuit 44 will be explained in reference to FIG. 4. In the present embodiment, each of the voltage Vi1 and the voltage Vi3 is equal to the voltage Vs.

Period T1

At a time t1, the switching element Q55 of the scan electrode drive circuit 43 is turned on. With this, the voltage Vs is applied to the scan electrodes SC1 to SCn via the switching elements Q55, Q63, Q64, and Q72L1 to Q72Ln. Then, the switching element Q63 is turned off, and the Miller integrator 61 is caused to start operating. With this, the rising ramp waveform voltage moderately rising from the voltage Vs to the voltage Vi2 is applied to the scan electrodes SC1 to SCn. During this, the switching element Q86 of the sustain electrode drive circuit 44 is turned on, and the voltage of 0 volt is applied to the sustain electrodes SU1 to SUn.

With this, the weak reset discharge is generated between the scan electrodes SC1 to SCn and the sustain electrodes SU1 to SUn and between the scan electrodes SC1 to SCn and the data electrodes D1 to Dm. Then, the negative wall voltage is accumulated on the portions above the scan electrodes SC1 to SCn, and the positive wall voltage is accumulated on the portions above the data electrodes D1 to Dm and the portions above the sustain electrodes SU1 to SUn.

Period T2

At a time t2, the Miller integrator 61 of the scan electrode drive circuit 43 is caused to stop operating, and the switching elements Q55 and Q63 are turned on. With this, the voltage Vs is applied to the scan electrodes SC1 to SCn. After that, the switching element Q64 is turned off, and the Miller integrator 62 is caused to start operating. With this, the falling ramp waveform voltage moderately falling from the voltage Vs to the lowest voltage Vi4 is applied to the scan electrodes SC1 to SCn. The falling ramp waveform voltage is applied in the periods T2 to T4.

Meanwhile, the switching element Q92 of the sustain electrode drive circuit 44 is turned on to apply the second voltage Ve2 to the sustain electrodes SU1 to SUn.

In the period T2, the weak reset discharge starts between the scan electrodes SC1 to SCn and the sustain electrodes SU1 to SUn.

Period T3

Next, at a time t3, the Miller integrator 93 of the sustain electrode drive circuit 44 is caused to start operating to apply to the sustain electrodes SU1 to SUn the rising ramp waveform voltage moderately rising from the second voltage Ve2 to the third voltage Ve3. During this, the weak reset discharge between the scan electrodes SC1 to SCn and the sustain electrodes SU1 to Sun weakens the negative wall voltage on the portions above the scan electrodes SC1 to SCn and the positive wall voltage on the portions above the sustain electrodes SU1 to SUn.

Period T4

At a time t4, the voltage applied to the sustain electrodes SU1 to SUn reaches the third voltage Ve3. After that, the voltage applied to the sustain electrodes SU1 to SUn is maintained to the third voltage Ve3. During this, in addition to the weak reset discharge between the scan electrodes SC1 to SCn and the sustain electrodes SU1 to SUn, the weak reset discharge is generated between the scan electrodes SC1 to SCn and the data electrodes D1 to Dm. Then, the negative wall voltage on the portions above the scan electrodes SC1 to SCn and the positive wall voltage on the portions above the sustain electrodes SU1 to SUn are weakened, and the positive wall voltage on the portions above the data electrodes D1 to Dm is adjusted to a value suitable for the address operation.

In the period between the time t2 and the time t4, the discharge (above-described strong discharge) is never generated between the scan electrodes SC1 to SCn and the data electrodes D1 to Dm, and after the time t4, the discharge (strong discharge) is generated between the scan electrodes SC1 to SCn and the data electrodes D1 to Dm. The time t3 is set as a time from which the waveform having the temporal gradient of 10V/μ or less can start when going back in time from the time t4.

Period T5

At a time t5 at which the voltage applied to the scan electrodes SC1 to SCn has fallen to the lowest voltage Vi4, the switching element Q73 of the scan electrode drive circuit 43 is turned on, the switching elements Q72L1 to Q72Ln of the scan pulse generating circuit 70 are turned off, and the switching elements Q72H1 to Q72Hn are turned on. With this, the voltage (Va+Vscn) is applied to the scan electrodes SC1 to SCn. The voltage (Va+Vscn) herein is the voltage Vc shown in FIG. 3. In the period T5, a priming effect caused by the discharge between the scan electrodes SC1 to SCn and the sustain electrodes SU1 to SUn and between the scan electrodes SC1 to SCn and the data electrodes D1 to Dm terminates. It is desirable that the period T5 be set between 5 μs and 50 μs.

After a predetermined period of time, the switching element Q92 of the sustain electrode drive circuit 44 is turned off, the Miller integrator 93 is caused to stop operating, and the switching element Q94 is turned on. With this, the fourth voltage Ve4 is applied to the sustain electrodes SU1 to SUn.

Address Period

The switching element Q72H1 of the scan electrode drive circuit 43 is turned off, and the switching element Q72L1 is turned on. With this, the voltage Va of the scan pulse is applied to the corresponding scan electrode SC1. After that, the switching element Q72L1 is turned off, and the switching element Q72H1 is turned on. With this, the scan pulse is applied to the scan electrode SC1. Similarly, the scan pulse is sequentially applied to the scan electrodes SC2 to SCn. During this, the fourth voltage Ve4 is applied to the sustain electrodes SU1 to SUn.

As above, the method for driving the PDP display apparatus according to the present invention can be realized by using the drive circuits shown in FIGS. 5 and 6. However, the drive circuits of the PDP display apparatus are not limited to the above drive circuits, and any drive circuits can be used as long as they can realize the drive voltage waveforms shown in FIGS. 3 and 4.

The present embodiment has explained a case where the value of the second voltage Ve2 applied to the sustain electrodes SU1 to SUn is different from the value of the fourth voltage Ve4. However, in a case where the value of the fourth voltage Ve4 is set to be the same as the value of the second voltage Ve2, the switching element Q94 and diode D94 of the reset-address voltage generating circuit 90 may be omitted.

Specific numerical values used in the present embodiment are just examples, and it is desirable that these numerical values be suitably set to appropriate values depending on the characteristics of the plasma display panel and the specs of the PDP display apparatus.

From the foregoing explanation, many modifications and other embodiments of the present invention are obvious to one skilled in the art. Therefore, the foregoing explanation should be interpreted only as an example, and is provided for the purpose of teaching the best mode for carrying out the present invention to one skilled in the art.

The structures and/or functional details may be substantially modified within the spirit of the present invention.

### INDUSTRIAL APPLICABILITY

The present invention can generate stable address discharge and carry out stable image display at high speed even in the case of the high-definition PDP display apparatus, so that the present invention is useful as the PDP display apparatus and the method for driving the PDP display apparatus.

1. A method for driving a plasma display panel display apparatus including a plurality of discharge cells respectively corresponding to plural pairs of display electrodes, each pair being constituted by a scan electrode and a sustain electrode, wherein
in a case of driving a plasma display panel for one field using a plurality of sub-fields each having a reset period in which reset discharge is generated in the discharge cell, an address period which is a period after the reset period and in which address discharge is generated in the discharge cell, and a sustain period which is a period after the address period and in which sustain discharge is generated in the discharge cell,
in the reset period, after a rising ramp waveform voltage is applied to the scan electrodes, and a first voltage is applied to the sustain electrodes, a falling ramp waveform voltage is applied to the scan electrodes, and a second voltage higher than the first voltage, a rising ramp waveform voltage rising from the second voltage to a third voltage higher than the second voltage, and the third voltage are sequentially applied to the sustain electrodes.

2. The method according to claim 1, wherein in the address period, a fourth voltage which is higher than the first voltage and is different from the third voltage is applied to the sustain electrodes, and a scan pulse of a voltage set to be lower than a lowest voltage of the falling ramp waveform voltage is sequentially applied to each of the scan electrodes.

3. The method according to claim 1, wherein:
the plasma display panel display apparatus further includes data electrodes intersecting with the pairs of display electrodes; and
the second voltage is set to a voltage which does not generate strong discharge between the sustain electrode and the data electrode or strong discharge between the sustain electrode and the scan electrode.

4. A plasma display panel display apparatus comprising:
a plasma display panel including a plurality of discharge cells respectively corresponding to plural pairs of display electrodes, each pair being constituted by a scan electrode and a sustain electrode; and
a controller configured to control the plasma display panel, wherein:
the controller is configured to control the plasma display panel for one field using a plurality of sub-fields each having a reset period in which reset discharge is generated in the discharge cell, an address period which is a period after the reset period and in which address discharge is generated in the discharge cell, and a sustain period which is a period after the address period and in which sustain discharge is generated in the discharge cell; and
the controller is also configured such that in the reset period, after a rising ramp waveform voltage is applied to the scan electrodes, and a first voltage is applied to the sustain electrodes, a falling ramp waveform voltage is applied to the scan electrodes, and a second voltage higher than the first voltage, a rising ramp waveform voltage rising from the second voltage to a third voltage higher than the second voltage, and the third voltage are sequentially applied to the sustain electrodes.

5. The plasma display panel display apparatus according to claim 4, wherein the controller is configured such that in the address period, a fourth voltage which is higher than the first voltage and is different from the third voltage is applied to the sustain electrodes, and a scan pulse of a voltage set to be lower than a lowest voltage of the falling ramp waveform voltage is sequentially applied to each of the scan electrodes.

6. The plasma display panel display apparatus according to claim 4, wherein:
the plasma display panel display apparatus further includes data electrodes intersecting with the pairs of display electrodes; and
the second voltage is set to a voltage which does not generate strong discharge between the sustain electrode and the data electrode or strong discharge between the sustain electrode and the scan electrode.
